(19) United States
(12) Patent Application Publication
(10) Pub. No.: US 2017/0141967 A1
(43) Pub. Date: May 18, 2017

(54) RESOURCE FORECASTING FOR ENTERPRISE APPLICATIONS

(71) Applicant: International Business Machines Corporation, Armonk, NY (US)

(72) Inventors: Madhuri Chawla, Mississauga (CA); Stephen P. Melvin, Westerville, OH (US)

(21) Appl. No.: 14/941,819

(22) Filed: Nov. 16, 2015

(51) Int. Cl. H04L 12/24; H04L 29/08

(52) U.S. Cl. CPC H04L 41/147; H04L 67/10; H04L 41/0813

(57) ABSTRACT

Resource forecasting is provided. A change factor of a deployment of an enterprise application software is identified. The change factor indicates a planned modification to the deployment. One or more parameters associated with the change factor are determined. An impact forecast of the change factor is generated based, at least in part, on resource consumption of the deployment, a system benchmark of the deployment, and resource performance data of the deployment. At least one capacity scaling recommendation is provided, wherein the at least one capacity scaling recommendation identifies a modification to an allocation of a computing resources based, at least in part, on the impact forecast.

### TECHNICAL FIELD

The present invention relates generally to the field of resource forecasting and, more particularly, to resource forecasting for enterprise applications.

### BACKGROUND OF THE INVENTION

Enterprises utilize software to accomplish various commercial goals. Enterprise software, also known as enterprise application software (“EAS”), is software designed to satisfy the needs of an organization rather than individual users. Such organizations can be, for example, businesses, schools, interest-based user groups and clubs, retailers, or governments. EAS can provide various business-oriented tools. Different organizations may deploy different EAS and/or different configurations of EAS. The computing resources required for a particular EAS can vary based on the deployment.

### SUMMARY

According to one embodiment of the present invention, a method for resource forecasting is provided. The method includes: identifying, by one or more processors, a change factor of a deployment of an enterprise application software, wherein the change factor indicates a planned modification to the deployment; determining, by one or more processors, one or more parameters associated with the change factor; generating, by one or more processors, an impact forecast of the change factor based, at least in part, on resource consumption of the deployment, a system benchmark of the deployment, and resource performance data of the deployment; and providing, by one or more processors, at least one capacity scaling recommendation, wherein the at least one capacity scaling recommendation identifies a modification to an allocation of a computing resources based, at least in part, on the impact forecast.

According to another embodiment of the present invention, a computer program product for resource forecasting is provided. The computer program product comprises a computer readable storage medium and program instructions stored on the computer readable storage medium. The program instructions include: program instructions to identify a change factor of a deployment of an enterprise application software, wherein the change factor indicates a planned modification to the deployment; program instructions to determine one or more parameters associated with the change factor; program instructions to generate an impact forecast of the change factor based, at least in part, on resource consumption of the deployment, a system benchmark of the deployment, and resource performance data of the deployment; and program instructions to provide at least one capacity scaling recommendation, wherein the at least one capacity scaling recommendation identifies a modification to an allocation of a computing resources based, at least in part, on the impact forecast.

According to another embodiment of the present invention, a computer system for resource forecasting is provided. The computer system includes one or more computer processors, one or more computer readable storage media, and program instructions stored on the computer readable storage media for execution by at least one of the one or more processors. The program instructions include: program instructions to identify a change factor of a deployment of an enterprise application software, wherein the change factor indicates a planned modification to the deployment; program instructions to determine one or more parameters associated with the change factor; program instructions to generate an impact forecast of the change factor based, at least in part, on resource consumption of the deployment, a system benchmark of the deployment, and resource performance data of the deployment; and program instructions to provide at least one capacity scaling recommendation, wherein the at least one capacity scaling recommendation identifies a modification to an allocation of a computing resources based, at least in part, on the impact forecast.

### BRIEF DESCRIPTION OF THE DRAWINGS

FIG. 1 is a functional block diagram illustrating a computing environment, in accordance with an embodiment of the present invention.

FIG. 2 is a flowchart depicting operations for resource forecasting, on a computing device within the computing environment of FIG. 1, in accordance with an embodiment of the present invention.

FIG. 3 depicts an example user interface, generally designated 300, in accordance with an embodiment of the present invention.

FIG. 4 is a block diagram of components of a computing device executing operations for resource forecasting, in accordance with an embodiment of the present invention.

### DETAILED DESCRIPTION

Embodiments of the present invention recognize a trend toward increasing complexity of analyzing the impact of business and technology changes to an existing enterprise system and its associated available computing resources. For example, enterprise deployments tend to be complex and subject to rapidly changing conditions. In other examples, businesses may modify enterprise deployments to adapt to market changes responsive to acquisitions, mergers, seasonal peak demand, or technology changes. Embodiments recognize that reducing the time required to analyze the impact of a business or technology change to an enterprise system facilitates more responsive resource allocation.

Embodiments of the present invention provide for forecasting the impact of a business or technology change to existing computing resources. Embodiments further provide for generating recommendations for modifying resource allocation based on the forecasted impact.

Embodiments of the present invention further provide for resource impact forecasting based on data from various sources. Some embodiments provide resource impact forecasting based on details of an enterprise application deployment and any anticipated future changes to the EAS deployment details. Some embodiments provide resource impact forecasting based on anticipated future changes to business or technology requirements on which an EAS deployment is based.

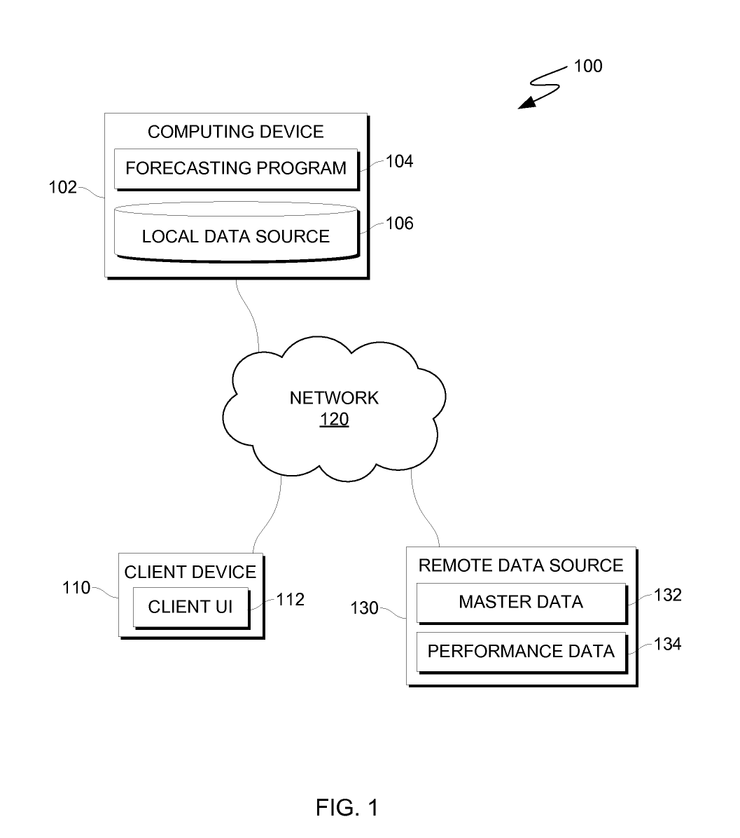

Embodiments of the present invention will now be described in detail with reference to the Figures. FIG. 1 is a functional block diagram illustrating a computing environment, in accordance with an embodiment of the present invention. For example, FIG. 1 is a functional block diagram illustrating computing environment 100. Computing environment 100 includes computing device 102, client device 110, and remote data source 130, connected over network 120. Computing device 102 includes forecasting program 104 and local data source 106.

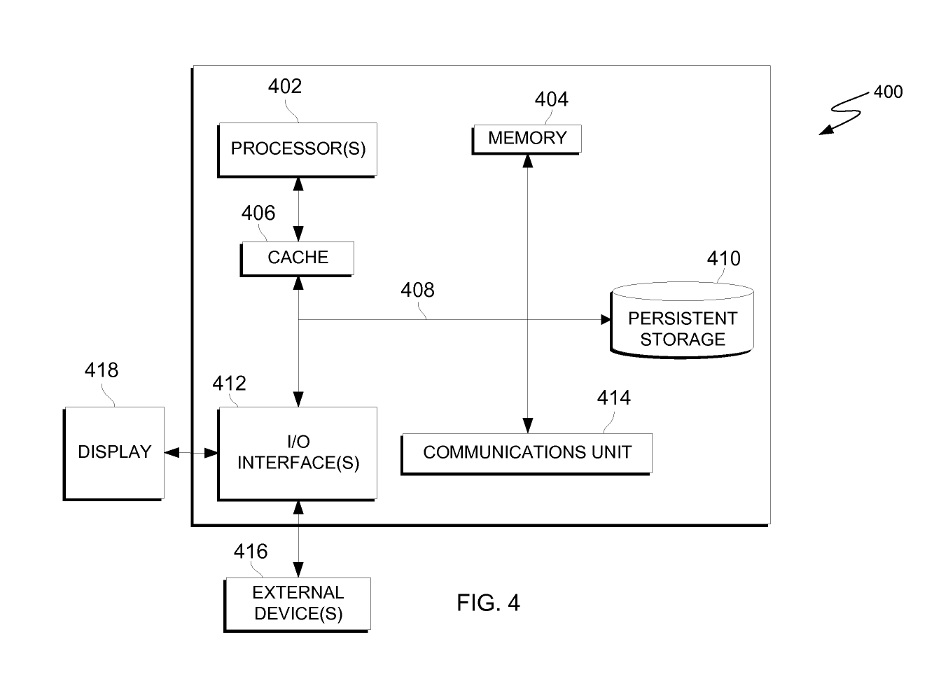

In various embodiments, computing device 102 is a computing device that can be a standalone device, a server, a laptop computer, a tablet computer, a netbook computer, a personal computer (PC), or a desktop computer. In another embodiment, computing device 102 represents a computing system utilizing clustered computers and components to act as a single pool of seamless resources. In general, computing device 102 can be any computing device or a combination of devices with access to client device 110, remote data source 130, and local data source 106, and with access to and/or capable of executing forecasting program 104. Computing device 102 may include internal and external hardware components, as depicted and described in further detail with respect to FIG. 4.

In this embodiment, forecasting program 104 and local data source 106 reside on computing device 102. In other embodiments, one or both of forecasting program 104 and local data source 106 may reside on another computing device, provided that each can access and is accessible by each other, and provided that forecasting program 104 can access client device 110 and remote data source 130. In yet other embodiments, one or both of forecasting program 104 and local data source 106 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between computing device 102, client device 110, and remote data source 130, in accordance with a desired embodiment of the present invention.

Forecasting program 104 operates to perform resource forecasting for enterprise applications. In one embodiment, forecasting program 104 generates an impact forecast for resources based, at least in part, on identified change factors and parameters associated with the change factors. In some embodiments, forecasting program 104 determines an impact forecast based, at least in part, on historical resource usage data. In some embodiments, forecasting program 104 presents a graphical representation based on an impact forecast, including a forecasting model and data associated with the forecast model. In one embodiment, forecasting program 104 generates an impact forecast based on existing implementation conditions of an EAS deployment. In another embodiment, forecasting program 104 generates an impact forecast based, at least in part, on immediate and future impacts of one or more anticipated changes to business and technology requirements.

In some embodiments, forecasting program 104 generates one or more capacity scaling recommendations. For example, forecasting program 104 may generate a recommendation to scale a resource to meet one or both of a current condition and an anticipated future condition. In some embodiment, forecasting program 104 forecasts time remaining until a particular resource reaches a critical state (e.g., a predetermined threshold) based, for example, on historical trends, predetermined growth, anticipated future changes, or a combination thereof.

Local data source 106 is a data repository that may be written to and read by forecasting program 104. Local data source 106 may store one or more change factors, each of which is associated with one or more fields. A value of a field is referred to as a parameter and is also associated with the change factor with which the field is associated. In some embodiments, local data source 106 stores cached data received by forecasting program 104 from remote data source 130. In some embodiments, local data source 106 may be written to and read by programs and entities outside of computing environment 100 in order to populate the repository with change factors and fields. In one example, a change factor is an EAS application upgrade, in which case fields include one or more of: upgrade type, EAS or relational database management software (RDBMS) vendor, EAS application, current release level, target release level, and planned upgrade date. In another example, a change factor is an increase in user base, in which case fields include or more of: EAS or RDBMS vendor, EAS application, user type, number of additional users, and planned date of addition. In yet another example, the change factor is the addition of one or more application modules, in which case the fields include one or more of: EAS or RDBMS vendor, EAS application, module to be added, number of users for module to be added, and planned date of addition. In some embodiments, local data source 106 also stores reference data including published EAS benchmark data, user impact data, module size (i.e., storage size) data, and text-based capacity scaling recommendations. User impact data specifies how much impact a user of a particular type has on resource consumption.

In some embodiments, local data source 106 also stores data validation rules applicable to the fields. In one embodiment, the data validation rules that apply to a field specify one or more valid parameter values of the field. For example, a data validation rule applies to a current release level field when an EAS application field has a particular value, in which case the data validation rule specifies one or more previously-released levels of the particular EAS software. In another embodiment, the data validation rules for a field specify a pattern or regular expression that matches valid parameter values of the field. For example, a data validation rule that applies to a planned upgrade date field is associated with a “mm/dd/yy” pattern, in which case valid parameter values of the planned upgrade date field include three two-digit numbers separated by backslashes such that the three two-digit numbers identify a date existing on a calendar prior to a current date. Multiple data validation rules may apply to a particular field using conjunctions such as Boolean logic (e.g., AND, OR, NOT) or other operators (e.g., IF/THEN).

Remote data source 130 represents one or more data repositories accessible by forecasting program 104. Remote data source 130 stores EAS deployment details, including master data 132 and performance data 134. In various examples, EAS deployment details also include some or all of: modules implemented, deployment customizations, and quantified impact of customizations. In some embodiments, remote data source 130 may be written to and read by programs and entities outside of computing environment 100 in order to populate the repository with EAS deployment details. In some embodiments, forecasting program 104 queries remote data source 130 to obtain EAS deployment details. In one embodiment, master data 132 and performance data 134 reside at least partially in the same repository of remote data source 130. In another embodiment, remote data source 130 represents one or more vendor repositories including master data 132 and an EAS repository including performance data 134.

Master data 132 includes, in various examples, some or all of: resource requirements corresponding to releases of a particular EAS, estimated average resource consumption by user and function, benchmark data for server hardware configurations, resource requirements associated with specific application modules, available software release levels, resource consumption deltas associated with software release levels, and available add-on applications.

Performance data 134 includes, in various examples, some or all of: overall resource consumption statistics, application-specific consumption for one or more resources, workload statistics, and user-related performance data. In some embodiments, performance data 134 may also store operational data specific to the processing characteristics and configuration of the machine or machines executing a particular EAS deployment. In one embodiment, performance data 134 is populated based on performance tables of an EAS deployment. For example, performance data 134 may include CPU utilization statistics, memory utilization statistics, disk activity (e.g., input/output) statistics, application workload statistics, or a combination thereof.

In some embodiments, one or both of local data source 106 and remote data source 130 also include additional data. For example, one or both of local data source 106 and remote data source 130 may also include some or all of: benchmark data for server hardware configurations, capacity requirement deltas associated with specific application modules, available software release levels, add-on applications, and deltas associated with specific types of users.

Client device 110 includes a user interface (UI), client UI 112, which executes locally on client device 110 and operates to provide a UI to a user of client device 110. Client UI 112 further operates to receive user input from a user via the provided user interface, thereby enabling the user to interact with client device 110. In one embodiment, client UI 112 provides a user interface that enables a user of client device 110 to interact with forecasting program 104 of computing device 102 via network 120. In various examples, the user interacts with forecasting program 104 in order to select one or more change factors, provide one or more parameter values, view the results of forecasting program 104 generating an impact forecast. In one embodiment, client UI 112 is stored on client device 110. In other embodiments, client UI 112 is stored on another computing device (e.g., computing device 102), provided that client UI 112 can access and is accessible by at least forecasting program 104.

In various embodiments, client device 110 is a computing device that can be a standalone device, a server, a laptop computer, a tablet computer, a netbook computer, a personal computer (PC), a desktop computer, a personal digital assistant (PDA), a smart phone, or any programmable electronic device capable of communicating with computing device 102 via network 120. In another embodiment, client device 110 represents a computing system utilizing clustered computers and components to act as a single pool of seamless resources. In general, client device 110 can be any computing device or a combination of devices with access to computing device 102, and with access to and/or capable of executing some or all of forecasting program 104 and local data source 106. Client device 110 may include internal and external hardware components, as depicted and described in further detail with respect to FIG. 4.

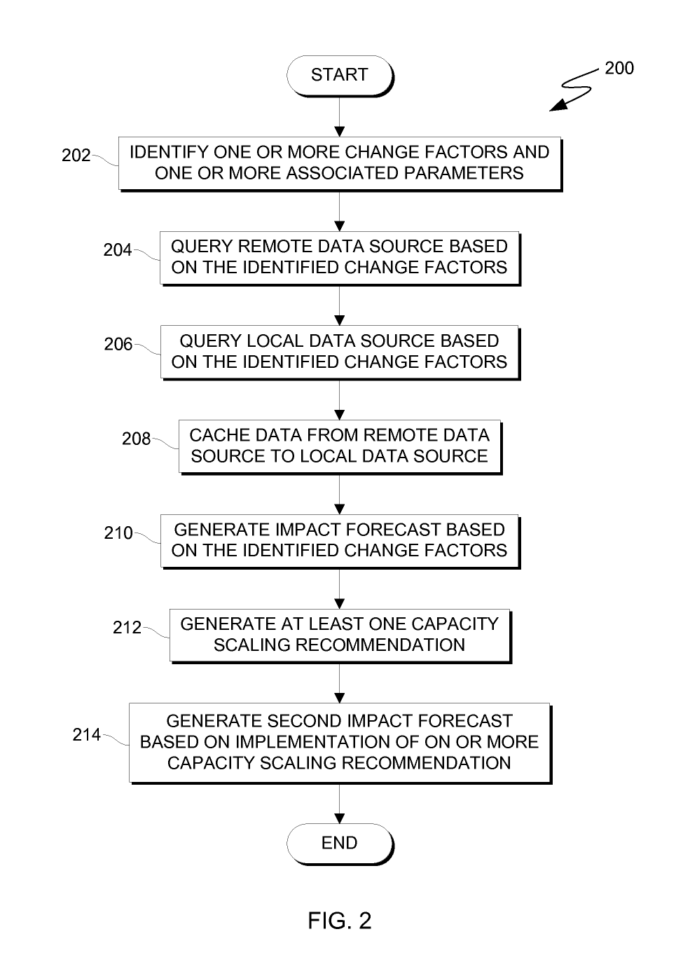

FIG. 2 is a flowchart depicting operations for resource forecasting, on a computing device within the computing environment of FIG. 1, in accordance with an embodiment of the present invention. For example, FIG. 2 is a flowchart depicting operations 200 of forecasting program 104 on computing device 102 within computing environment 100.

In operation 202, forecasting program 104 identifies one or more change factors and one or more associated fields. In one embodiment, forecasting program 104 identifies change factors and fields based on user input. For example, the change factor that forecasting program 104 identifies is an increase in user base and a corresponding parameter is a number of additional users. In one embodiment, forecasting program 104 receives the user input, via client UI 112 of client device 110. In some embodiments, forecasting program 104 validates the value of each field (i.e., each parameter) based on one or more data validation rules that apply to the field.

In operation 204, forecasting program 104 queries a remote data source based on the identified change factors. In some embodiments, the query is further based on the one or more fields associated with the identified change factors. In one embodiment, forecasting program 104 queries remote data source 130. In this case, forecasting program 104 queries remote data source 130 for information from one or both of master data 132 and performance data 134. Forecasting program 104 queries remote data source 130 for information that corresponds to each change factor.

In operation 206, forecasting program 104 queries a local data source based on the identified change factors. In some embodiments, the query is further based on the one or more fields associated with the identified change factors. In one embodiment, forecasting program 104 queries local data source 106. In this case, forecasting program 104 receives, from local data source 106, reference data corresponding to the identified change factors. For example, in response to a query based on a change factor and parameter specifying the addition of a particular application module, forecasting program 104 receives reference data including module sizing data and processing load for the particular application module.

In operation 208, forecasting program 104 caches data from a remote data source to a local data source. Forecasting program 104 caches the data received from the remote data source in operation 204 to the local data source that forecasting program 104 queried in operation 206. For example, forecasting program 104 caches data received from remote data source 130 to local data source 106 by causing local data source 106 to store the data.

In operation 210, forecasting program 104 generates an impact forecast based on the identified change factors. The impact forecast identifies hypothetical utilization of one or more resources if the change described by the identified change factor and associated parameters were implemented. Resources include computing resources with measureable availability or utilization (e.g., processors, memory, storage, storage input/output, network input/output). In some embodiments, an impact forecast includes impacts to one or more performance metrics (e.g., response times, processing times, data resiliency) of an EAS deployment.

In one example, forecasting program 104 generates the impact forecast based on input including performance data received from remote data source 130. In this case, forecasting program 104 processes the input by one or more of capacity analysis, simulations, processing, and guidance processing logic in order to determine the hypothetical utilization of one or more resources.

In operation 212, forecasting program 104 generates at least one capacity scaling recommendations. In one embodiment, forecasting program 104 presents the impact forecast via a user interface, which may include presenting graphical and/or text content. The user interface may provide interactive UI elements to control the display of data resulting from the impact forecast analysis including, for example, graphs, text, or other data. A first example UI element controls the display of data describing existing capacity constraints. A second example UI element controls the display of results of a simulation of a workload associated with the identified change factor over existing computing resources, thereby indicating additional workload associated with the identified change factor. A third example UI element controls the display of an estimated timeline of when capacity constraints could occur based on current growth rates. A fourth example UI element controls the display of an estimated timeline of when capacity constraints could occur if a change factor is implemented with capacity scaling recommendations.

Forecasting program 104 generates the at least one capacity scaling recommendation based on the impact forecast. In one embodiment, forecasting program 104 generates a capacity scaling recommendation based on data received from local data source 106. Forecasting program 104 presents the capacity scaling recommendation via the UI. In one example, forecasting program 104 recommends increasing the capacity of a resource in response to determining that the existing capacity has been met within a predetermined threshold. In another example, forecasting program 104 recommends decreasing the capacity of a resource in response to determining that utilization of the resource under the conditions are below a predetermined threshold in a simulation of a workload associated with the identified change factor. In another example, forecasting program 104 recommends adjusting a capacity of a resource at a specified future date based on an estimated timeline predicting future growth rates or an impact on current or future growth rates if a change factor is implemented.

In operation 214, forecasting program 104 generates a second impact forecast based on implementation of at least one capacity scaling recommendation. Forecasting program 104 receives a user interaction selecting one or more capacity scaling recommendations. Forecasting program 104 generates a second impact forecast with starting conditions (e.g., available resources, modules running, number of users) adjusted according to the selected one or more capacity scaling recommendations.

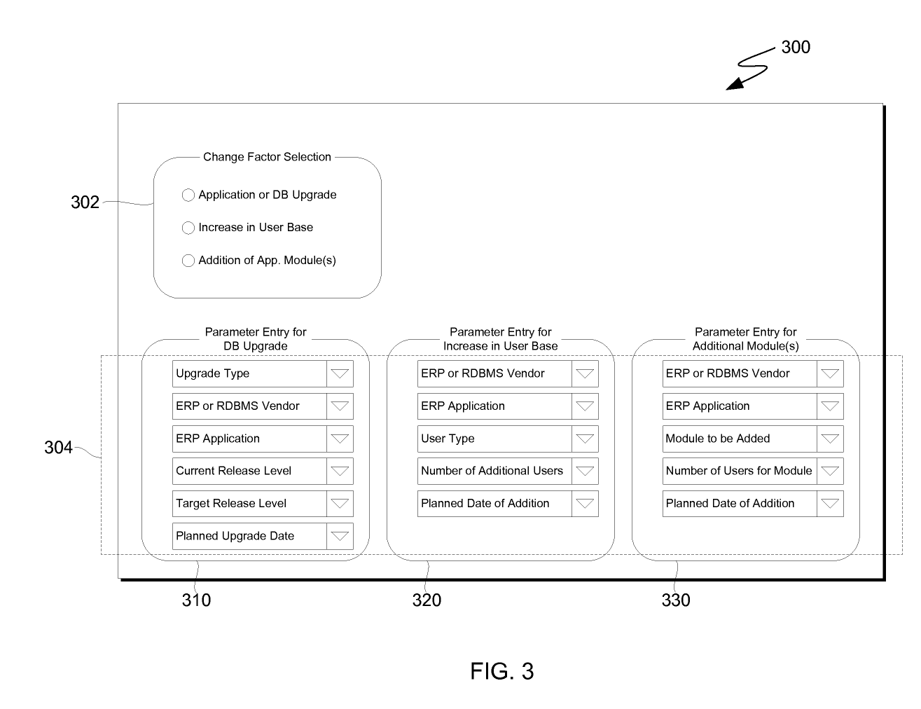

FIG. 3 depicts an example user interface, generally designated 300, in accordance with an embodiment of the present invention. In one embodiment, client UI 112 includes user interface 300. In another embodiment, user interface 300 is presented via a user interface of computing device 102.

Forecasting program 104 receives user input via user interface 300. In the depicted example, forecasting program 104 receives user input identifying a change factor via change factor selection element 302.

Parameter entry groups 310, 320, and 330 are elements of user interface 300 via which forecasting program 104 receives parameter values of fields associated with a corresponding change factor. Parameter entry groups 310, 320, and 330 correspond, respectively, to the change factors “Application or DB Upgrade”, “Increase in User Base”, and “Addition of App. Module(s)” listed in change factor selection element 302. In one embodiment, change factor selection element 302 allows identification of one or more change factors. Forecasting program 104 receives parameters associated with each identified change factor. In one embodiment, user interface 300 may concurrently allow entry of parameters associated with the one or more identified change factors. In another embodiment, user interface 300 allows entry of parameters associated with each identified change factor sequentially.

For convenience of description, user interface 300 is depicted as including each of parameter entry groups 310, 320, and 330. In one embodiment, user interface 300 presents a parameter entry element in response to a user interaction via change factor selection element 302 that identifies a change factor to which the parameter entry element corresponds. In another embodiment, user interface 300 presents one or more of parameter entry groups 310, 320, and 330. In some embodiments, user interface 300 may concurrently present parameter entry groups 310, 320, and 330. In some embodiments, user interface 300 enables interaction with parameter elements 304 of a parameter entry group only when the corresponding change factor is identified via change factor selection element 302.

Each parameter elements 304 is a user interface element via which forecasting program 104 receives a value of a field associated with a change factor. In the depicted example, each of parameter entry groups 310, 320, and 330 include multiple parameter elements 304. Generally, a parameter entry group (e.g., parameter entry group 310, 320, 330) may include zero or more parameter elements 304.

FIG. 4 is a block diagram of components of a computing device, generally designated 400, in accordance with an embodiment of the present invention. In one embodiment, computing system 400 is representative of computing device 102 within computing environment 100, in which case computing device 102 includes forecasting program 104 and local data source 106. In another embodiment, computing system 400 is representative of remote data source 130 within computing environment 100, in which case remote data source 130 includes master data 132 and performance data 134.

It should be appreciated that FIG. 4 provides only an illustration of one implementation and does not imply any limitations with regard to the environments in which different embodiments may be implemented. Many modifications to the depicted environment may be made.

Computing system 400 includes processor(s) 402, cache 406, memory 404, persistent storage 410, input/output (I/O) interface(s) 412, communications unit 414, and communications fabric 408. Communications fabric 408 provides communications between cache 406, memory 404, persistent storage 410, communications unit 414, and input/output (I/O) interface(s) 412. Communications fabric 408 can be implemented with any architecture designed for passing data and/or control information between processors (such as microprocessors, communications and network processors, etc.), system memory, peripheral devices, and any other hardware components within a system. For example, communications fabric 408 can be implemented with one or more buses or a crossbar switch.

Memory 404 and persistent storage 410 are computer readable storage media. In this embodiment, memory 404 includes random access memory (RAM). In general, memory 404 can include any suitable volatile or non-volatile computer readable storage media. Cache 406 is a fast memory that enhances the performance of processor(s) 402 by holding recently accessed data, and data near recently accessed data, from memory 404.

Program instructions and data used to practice embodiments of the present invention may be stored in persistent storage 410 and in memory 404 for execution by one or more of the respective processor(s) 402 via cache 406. In an embodiment, persistent storage 410 includes a magnetic hard disk drive. Alternatively, or in addition to a magnetic hard disk drive, persistent storage 410 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 410 may also be removable. For example, a removable hard drive may be used for persistent storage 410. Other examples include optical and magnetic disks, thumb drives, and smart cards that are inserted into a drive for transfer onto another computer readable storage medium that is also part of persistent storage 410.

Communications unit 414, in these examples, provides for communications with other data processing systems or devices. In these examples, communications unit 414 includes one or more network interface cards. Communications unit 414 may provide communications through the use of either or both physical and wireless communications links. Program instructions and data used to practice embodiments of the present invention may be downloaded to persistent storage 410 through communications unit 414.

I/O interface(s) 412 allows for input and output of data with other devices that may be connected to each computer system. For example, I/O interface(s) 412 may provide a connection to external device(s) 416 such as a keyboard, keypad, a touch screen, and/or some other suitable input device. External device(s) 416 can also include portable computer readable storage media such as, for example, thumb drives, portable optical or magnetic disks, and memory cards. Software and data used to practice embodiments of the present invention can be stored on such portable computer readable storage media and can be loaded onto persistent storage 410 via I/O interface(s) 412. I/O interface(s) 412 also connect to display 418.

Display 418 provides a mechanism to display or present data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The term(s) “Smalltalk” and the like may be subject to trademark rights in various jurisdictions throughout the world and are used here only in reference to the products or services properly denominated by the marks to the extent that such trademark rights may exist.

The term “exemplary” means of or relating to an example and should not be construed to indicate that any particular embodiment is preferred relative to any other embodiment.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for resource forecasting, comprising:
identifying, by one or more processors, a change factor of a deployment of an enterprise application software, wherein the change factor indicates a planned modification to the deployment;
determining, by one or more processors, one or more parameters associated with the change factor;
generating, by one or more processors, an impact forecast of the change factor based, at least in part, on resource consumption of the deployment, a system benchmark of the deployment, and resource performance data of the deployment; and
providing, by one or more processors, at least one capacity scaling recommendation, wherein the at least one capacity scaling recommendation identifies a modification to an allocation of a computing resources based, at least in part, on the impact forecast.

2. The method of claim 1, further comprising:
receiving, by one or more processors, an indication to implement the at least one capacity scaling recommendation and, in response, generating a second impact forecast based, at least in part, on the change factor and implementation of the at least one capacity scaling recommendation.

3. The method of claim 1, further comprising:
receiving, by one or more processors, the resource performance data of the deployment from a remote data source, wherein the remote data source includes a performance table of the enterprise application software.

4. The method of claim 1, wherein generating the impact forecast is further based, at least in part, on the one or more parameters associated with the change factor.

5. The method of claim 1, wherein the change factor is one of: upgrading to one or more existing software modules, installation of one or more new software modules, or modifying a count of user.

6. The method of claim 1, wherein the impact forecast identifies one or more of: existing capacity constraints of the deployment; additional workload associated with the change factor; a first estimated timeline of when capacity constraints could occur based on current growth rates; a second estimated timeline of when capacity constraints could occur if the change factor is implemented with capacity scaling recommendations.

7. The method of claim 1, wherein the impact forecast includes an impact to at least one performance metric of the deployment based, at least in part, on the change factor, wherein the at least on performance metric includes one of: a response time of the deployment, a processing time of the deployment, at data resiliency of the deployment.

8. A computer program product for resource forecasting, the computer program product comprising:
a computer readable storage medium and program instructions stored on the computer readable storage medium, the program instructions comprising:
program instructions to identify a change factor of a deployment of an enterprise application software, wherein the change factor indicates a planned modification to the deployment;
program instructions to determine one or more parameters associated with the change factor;
program instructions to generate an impact forecast of the change factor based, at least in part, on resource consumption of the deployment, a system benchmark of the deployment, and resource performance data of the deployment; and
program instructions to provide at least one capacity scaling recommendation, wherein the at least one capacity scaling recommendation identifies a modification to an allocation of a computing resources based, at least in part, on the impact forecast.

9. The computer program product of claim 8, the program instructions further comprising:
program instructions to receive an indication to implement the at least one capacity scaling recommendation and, in response, generate a second impact forecast based, at least in part, on the change factor and implementation of the at least one capacity scaling recommendation.

10. The computer program product of claim 8, the program instructions further comprising:
program instructions to receive the resource performance data of the deployment from a remote data source, wherein the remote data source includes a performance table of the enterprise application software.

11. The computer program product of claim 8, wherein generating the impact forecast is further based, at least in part, on the one or more parameters associated with the change factor.

12. The computer program product of claim 8, wherein the change factor is one of: upgrading to one or more existing software modules, installation of one or more new software modules, or modifying a count of user.

13. The computer program product of claim 8, wherein the impact forecast identifies one or more of: existing capacity constraints of the deployment; additional workload associated with the change factor; a first estimated timeline of when capacity constraints could occur based on current growth rates; a second estimated timeline of when capacity constraints could occur if the change factor is implemented with capacity scaling recommendations.

14. The computer program product of claim 8, wherein the impact forecast includes an impact to at least one performance metric of the deployment based, at least in part, on the change factor, wherein the at least on performance metric includes one of: a response time of the deployment, a processing time of the deployment, at data resiliency of the deployment.

15. A computer system for resource forecasting, the computer system comprising:
one or more computer processors;
one or more computer readable storage media;
program instructions stored on the one or more computer readable storage media for execution by at least one of the one or more processors, the program instructions comprising:
program instructions to identify a change factor of a deployment of an enterprise application software, wherein the change factor indicates a planned modification to the deployment;
program instructions to determine one or more parameters associated with the change factor;
program instructions to generate an impact forecast of the change factor based, at least in part, on resource consumption of the deployment, a system benchmark of the deployment, and resource performance data of the deployment; and
program instructions to provide at least one capacity scaling recommendation, wherein the at least one capacity scaling recommendation identifies a modification to an allocation of a computing resources based, at least in part, on the impact forecast.

16. The computer system of claim 15, the program instructions further comprising:
program instructions to receive an indication to implement the at least one capacity scaling recommendation and, in response, generate a second impact forecast based, at least in part, on the change factor and implementation of the at least one capacity scaling recommendation.

17. The computer system of claim 15, the program instructions further comprising:
program instructions to receive the resource performance data of the deployment from a remote data source, wherein the remote data source includes a performance table of the enterprise application software.

18. The computer system of claim 15, wherein generating the impact forecast is further based, at least in part, on the one or more parameters associated with the change factor.

19. The computer system of claim 15, wherein the change factor is one of: upgrading to one or more existing software modules, installation of one or more new software modules, or modifying a count of user.

20. The computer system of claim 15, wherein the impact forecast identifies one or more of: existing capacity constraints of the deployment; additional workload associated with the change factor; a first estimated timeline of when capacity constraints could occur based on current growth rates; a second estimated timeline of when capacity constraints could occur if the change factor is implemented with capacity scaling recommendations.
